(19) United States
(12) Patent Application Publication
(10) Pub. No.: US 2008/0151042 A1
(43) Pub. Date: Jun. 26, 2008

(54) Method and apparatus of generating image data having parallax, and image sensing module

(75) Inventor: Hsin-Te Wang, Caotun Town (TW)

Correspondence Address: MCDERMOTT WILL & EMERY LLP, 18191 VON KARMAN AVE., SUITE 500, IRVINE, CA, 92612-7108, US

(73) Assignee: Altek Corporation, Hsinchu (TW)

(21) Appl. No.: 11/797,250

(22) Filed: May 2, 2007

(30) Foreign Application Priority Data
Dec. 21, 2006 (TW) 095148276

(51) Int. Cl. H04N 13/02

(52) U.S. Cl. 348/49; 348/E13.074

(57) ABSTRACT

A method of generating image data having disparity (or parallax) using a digital image-capturing device, as well as a digital image-capturing device are disclosed. The feature is to rotate a focus lens of the digital image-capturing device at two opposite directions or to place a refractive sheet having two opposite refractive directions in front of an image sensor of the digital image-capturing device. Also disclosed are a method and a device of generating stereoscopic image using the generated image data having disparity.

### FIELD OF THE INVENTION

The invention relates to the stereoscopic image technology, to the parallax/disparity technology in the stereoscopic image technology, more particularly to a method of generating image data having parallax by using a digital image-capturing device such as a digital camera or a digital camcorder, and further to the digital image-capturing device, an image sensing module, a method and device of generating a stereoscopic image.

### BACKGROUND OF THE INVENTION

Conventional stereoscopic image technology is generally classified into two types, i.e., holography technology and parallax technology. The holography technology employs the wavefront reconstruction method to make human eyes receive reflective light identical to that emitted by a real object so as to perceive the stereoscopic image.

The parallax technology utilizes human's binocular disparity or parallax effect. As shown in FIG. 1, the left eye 11 and right eye 12 of a viewer respectively see an object 13 at a viewing angle Θ. Because of the distance between the left eye 11 and right eye 12, the left eye 11 and right eye 12 respectively receive an image different from each other, i.e., the images having parallax, which are then synthesized by the human brain forming the stereoscopic image of the object 13. Based thereon, the parallax technology produces images having parallax as those received by the left eye and right eye of a human, and makes the left eye and right eye of a viewer respectively receive, through a pair of 3D spectacles, the images having parallax. The stereoscopic image is then formed in the brain of the viewer.

It is difficult to produce images having parallax for forming a stereoscopic image. Generally, it requires professional and expensive photographic equipments such as a fisheye camera with dual lenses, making ordinary consumers hardly perform such production themselves.

### SUMMARY OF THE INVENTION

One objective of the invention is to provide a method of generating image data having parallax by using a digital image-capturing device for generating a stereoscopic image.

Another objective of the invention is to provide a method and a device of generating a stereoscopic image, making it easy to see the stereoscopic image generated from the image having parallax.

According to one aspect of the invention, there is provided a method of generating image data having parallax by using a digital image-capturing device, the digital image-capturing device using a focus lens to focus a received image onto an image sensing device, so as to convert a focused image into image data of electrical form, the focus lens being movably connected to the digital image-capturing device, the method comprising: rotating the focus lens toward a first direction by a first angle, to cause the image sensing device to obtain a first image data; and rotating the focus lens toward a second direction opposite to the first direction by a second angle, to cause the image sensing device to obtain a second image data having parallax with respect to the first image data.

According to another aspect of the invention, there is provided a method of generating image data having parallax by using a digital image-capturing device, the digital image-capturing device using an image sensing device to convert a focused image into image data of electrical form, the image sensing device having a plurality of image sensing units, the method comprising: providing a refraction plate having a plurality of refraction regions, two adjacent refraction regions respectively having a first refraction direction and a second refraction direction opposite to the first refraction direction; and placing the refraction plate in contact with the image sensing device in such a way that the plurality of refraction regions respectively correspond to the plurality of image sensing units, so as to obtain, from the image sensing device, image data of the first refraction direction and image data of the second refraction direction having parallax with respect to the image data of the first refraction direction.

According to further aspect of the invention, there is provided a digital image-capturing device for selectively generating image data having parallax, the digital image-capturing device comprising: a focus lens movably connected to the digital image-capturing device for focusing a received image; and an image sensing device for converting a focused image into image data of electrical form, wherein the image sensing device obtains a first image data when the focus lens is rotated toward a first direction by a first angle, and the image sensing device obtains a second image data having parallax with respect to the first image data when the focus lens is rotated toward a second direction opposite to the first direction by a second angle.

According to yet another aspect of the invention, there is provided a digital image-capturing device for generating image data having parallax, the digital image-capturing device comprising: an image sensing device for converting a received image into image data of electrical form, the image sensing device having a plurality of image sensing units; and a refraction plate contacting the image sensing device and having a plurality of refraction regions respectively corresponding to the plurality of image sensing units, two adjacent refraction regions respectively having a first refraction direction and a second refraction direction opposite to the first refraction direction, causing the image sensing device to obtain image data of the first refraction direction and image data of the second refraction direction having parallax with respect to the image data of the first refraction direction.

According to yet further aspect of the invention, there is provided an image sensing module, comprising: an image sensing device for converting a received image into image data of electrical form, the image sensing device having a plurality of image sensing units; and a refraction plate contacting the image sensing device and having a plurality of refraction regions respectively corresponding to the plurality of image sensing units, two adjacent refraction regions respectively having a first refraction direction and a second refraction direction opposite to the first refraction direction, to cause the image sensing device to obtain image data of the first refraction direction and image data of the second refraction direction having parallax with respect to the image data of the first refraction direction.

According to still another aspect of the invention, there is provided a method of generating a stereoscopic image, comprising: providing a display device having a plurality of pixels and receiving image data of a first refraction direction and image data of a second refraction direction having parallax with respect to the image data of the first refraction direction, the first refraction direction being opposite to the second refraction direction; alternately displaying image data of the first refraction direction and image data of the second refraction direction at adjacent pixels; providing a refraction plate having a plurality of refraction regions, two adjacent refraction regions respectively having the first refraction direction and the second refraction direction; and causing the refraction regions having the first refraction direction and the refraction regions having the second refraction direction to respectively correspond to the adjacent pixels alternately displaying image data of the first refraction direction and image data of the second refraction direction, such that a viewer can see the stereoscopic image when viewing the displayed image through the refraction plate.

According to still further aspect of the invention, there is provided a stereoscopic image generating device, comprising: a display device having a plurality of pixels and receiving image data of a first refraction direction and image data of a second refraction direction having parallax with respect to the image data of the first refraction direction, and alternately displaying image data of the first refraction direction and image data of the second refraction direction at adjacent pixels, the first refraction direction being opposite to the second refraction direction; and a refraction plate in close proximity to the display device and having a plurality of refraction regions, two adjacent refraction regions respectively having the first refraction direction and the second refraction direction, wherein the refraction regions having the first refraction direction and the refraction regions having the second refraction direction respectively correspond to the adjacent pixels alternately displaying image data of the first refraction direction and image data of the second refraction direction, such that a viewer can see the stereoscopic image when viewing the displayed image through the refraction plate.

### BRIEF DESCRIPTION OF DRAWINGS

The foregoing and advantages of the invention will be appreciated more fully from the following further description thereof with reference to the accompanying drawings wherein:

FIG. 1 shows the parallax effect of the left eye and right eye of a human-being.

FIG. 2 shows a flow chart of a method of a specific embodiment of the invention for generating image data having parallax by using a digital image-capturing device.

FIGS. 3A, 3B, and 3C respectively show a status of a specific embodiment of a digital image-capturing device implementing the method of FIG. 2.

FIGS. 4A, 4B, and 4C respectively show an object image having parallax to each other obtained from the image-capturing device of FIGS. 3A, 3B, and 3C.

FIG. 5 shows a flow chart of a method of another specific embodiment of the invention for generating image data having parallax by using a digital image-capturing device.

FIG. 6 shows a structural diagram of a specific embodiment of a digital image-capturing device implementing the method of FIG. 5.

FIG. 7 shows an object image having parallax obtained from the image-capturing device of FIG. 6.

FIG. 8 shows a structural diagram of an image sensing module of a specific embodiment of the invention.

FIG. 9 shows a flow chart of a method of a specific embodiment of the invention for generating a stereoscopic image.

FIG. 10 shows a structural diagram of a specific embodiment of a stereoscopic image generating device implementing the method of FIG. 9.

### DETAILED DESCRIPTION OF SPECIFIC EMBODIMENTS

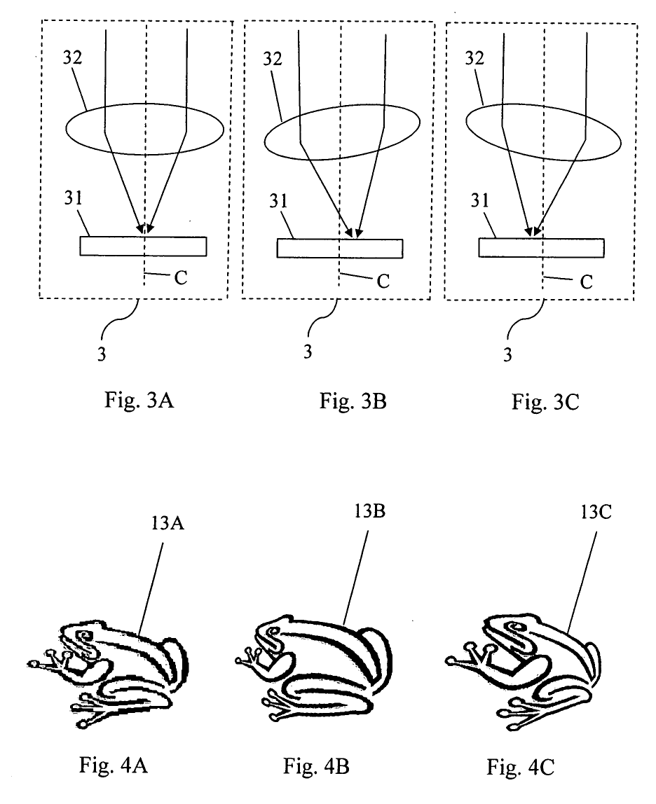

FIG. 2 shows a flow chart of a method of a specific embodiment of the invention for generating image data having parallax by using a digital image-capturing device. FIGS. 3A, 3B, and 3C respectively show a status of a specific embodiment of a digital image-capturing device implementing the method of FIG. 2. FIGS. 4A, 4B, and 4C respectively show an object image having parallax obtained from the image-capturing device of FIGS. 3A, 3B, and 3C.

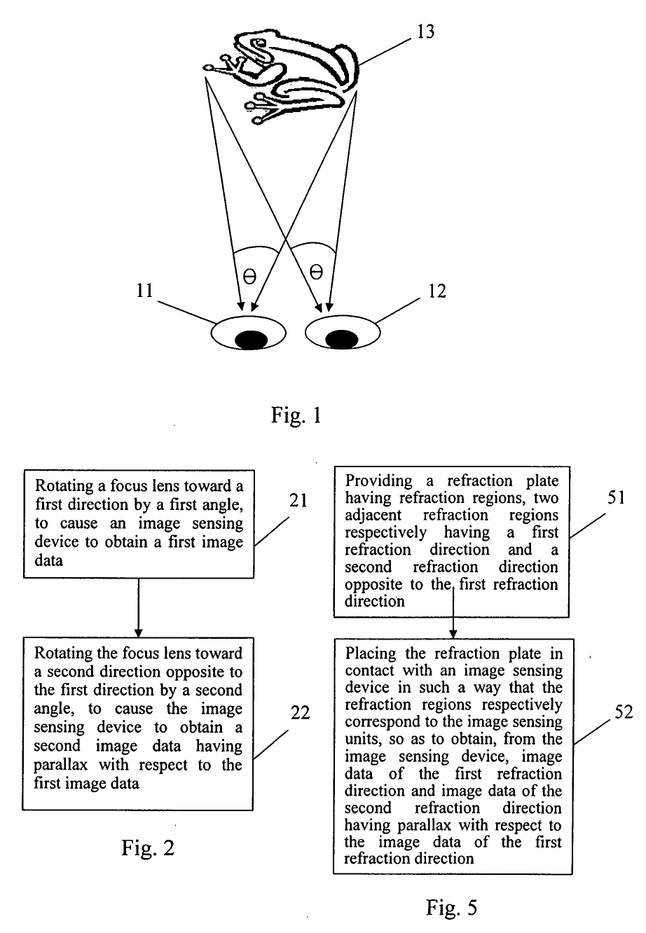

In the specific embodiment of the invention as shown in FIG. 3A, a digital image-capturing device 3 includes an image sensing device 31 such as a CCD, and a focus lens 32. As in a typical digital image-capturing device, the focus lens 32 focuses a received image onto the image sensing device 31, so as to convert the focused image into image data of electrical form, where the image focusing is centered at the optical axis C. If the photographed target is the object 13 in FIG. 1, the image data obtained from the image sensing device 31 appear to be the image 13A shown in FIG. 4A, as the object 13.

In the status of FIG. 3B, the focus lens 32 is rotated counterclockwise (the first direction) by an angle (the first angle) according to the step 21 in FIG. 2, such that the image is focused at the right side of the optical axis C, and the image data (the first data) obtained from the image sensing device 31 appear to be the image 13B as shown in FIG. 4B. Compared to the image 13A in FIG. 4A, the image 13B is larger at its right half, but smaller at its left half.

In the status of FIG. 3C, the focus lens 32 is rotated clockwise (the second direction) by an angle (the second angle) according to the step 22 in FIG. 2, such that the image is focused at the left side of the optical axis C, and the image data (the second data) obtained from the image sensing device 31 appear to be the image 13C as shown in FIG. 4C. Compared to the image 13A in FIG. 4A, the image 13C is smaller at its right half, but larger at its left half. Thus, there is parallax between the image 13C and the image 13B.

The first angle can be equal or unequal to the second angle. If unequal, the obtained image data having parallax can be further properly processed by the image processing unit in a typical digital image-capturing device.

The focus lens 32 can be movably connected to the digital image-capturing device 3 using various suitable mechanisms such as linkages, guides, etc., such that focus lens 32 can be rotated toward different directions by particular angles.

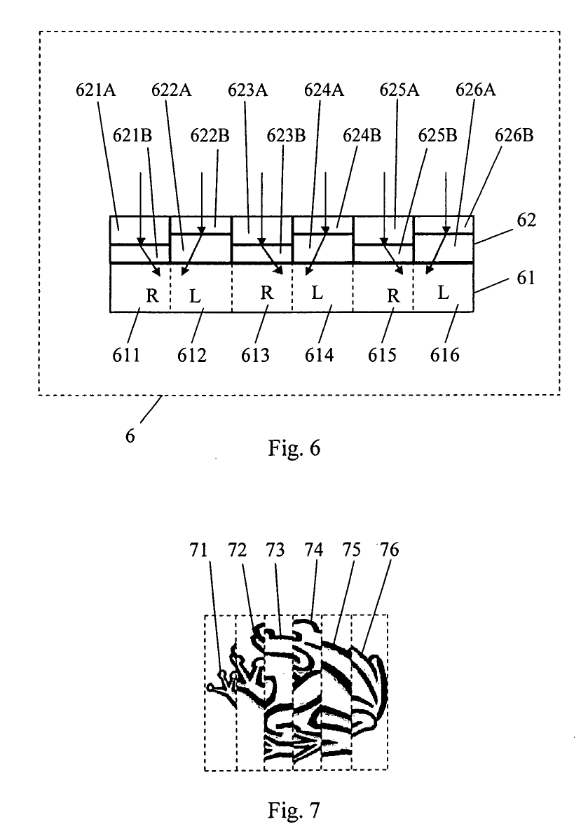

FIG. 5 shows a flow chart of a method of another specific embodiment for generating image data having parallax by using a digital image-capturing device. FIG. 6 shows a structural diagram of a specific embodiment of a digital image-capturing device implementing the method of FIG. 5. FIG. 7 shows an object image having parallax obtained from the image-capturing device of FIG. 6.

The digital image-capturing device 6 in FIG. 6 includes an image sensing device 61, which can convert the focused image into the image data of electrical form, as with the image sensing device 31 such as a CCD. The image sensing device 61 includes a plurality of image sensing units (pixels) 611-612-613-614-615-616.

As shown in step 51 of FIG. 5, the digital image-capturing device 6 in FIG. 6 further includes a refraction plate 62 having a plurality of refraction regions formed by layers 621A and 621B, 622A and 622B, 623A and 623B, 624A and 624B, 625A and 625B, and 626A and 626B, respectively. Each refraction region is formed by stacking two layers of different materials such as polymers like polyimide, polycarbonate, etc. Two adjacent refraction regions respectively have a layer thickness different from each other. For example, the layer thickness of each of layers 621A and 621B forming a refraction region is different from that of each of layers 622A and 622B forming an adjacent refraction region. Thus, two adjacent refraction regions respectively have a refraction direction opposite to each other. For example, the refraction region formed by layers 621A and 621B causes the light entering this region to deflect toward the right side (R), but the adjacent refraction region formed by layers 622A and 622B causes the light entering this region to deflect toward the left side (L).

As shown in step 52 of FIG. 5, the refraction plate 62 of FIG. 6 is placed in contact with the image sensing device 61 in such a way that the plurality of the refraction regions respectively correspond to the plurality of the image sensing units. For example, the refraction region formed by layers 621A and 621B corresponds to the image sensing unit 611, and the refraction region formed by layers 622A and 622B corresponds to the image sensing unit 612. Thus, image data having parallax, i.e., the image data formed by the light deflecting toward the right side (R), and the image data formed by the light deflecting toward the left side (L), can be obtained from the image sensing device 61. As shown in FIG. 7, the light deflecting toward the right side (R) forms image 71, 73, and 75, and the light deflecting toward the left side (L) forms image 72, 74, and 76, just as the image having parallax which is formed by alternately combining a portion of image 13B of FIG. 4B and a portion of image 13C of FIG. 4C.

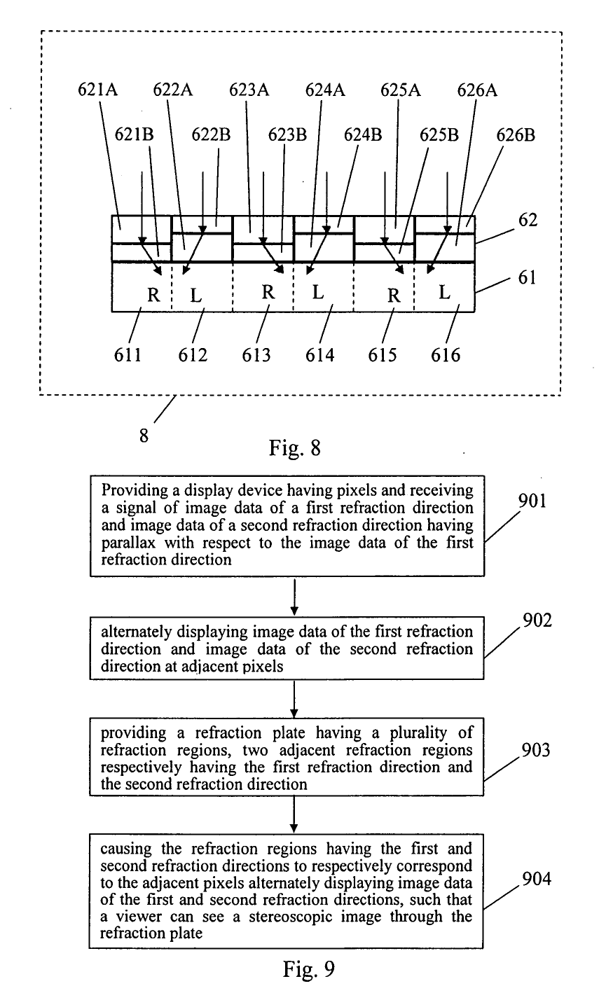

The image sensing device 61 and the refraction plate 62 may form an image sensing module 8 as shown in FIG. 8, where the image sensing units 611, 612, 613, 614, 615, and 616 of the image sensing device 61 respectively correspond to the refraction regions of the refraction plate 62 formed by layers 621A and 621B, 622A and 622B, 623A and 623B, 624A and 624B, 625A and 625B, 626A and 626B, respectively.

In order to observe the stereoscopic image generated from the first image data and the second image data having parallax with respect to the first image data obtained from FIG. 2, a pair of conventional 3D spectacles (not shown) can be used to make the left eye and right eye of a viewer respectively receive the first image and the second image having parallax, and then the brain of the viewer synthesizes such images to render the stereoscopic effect.

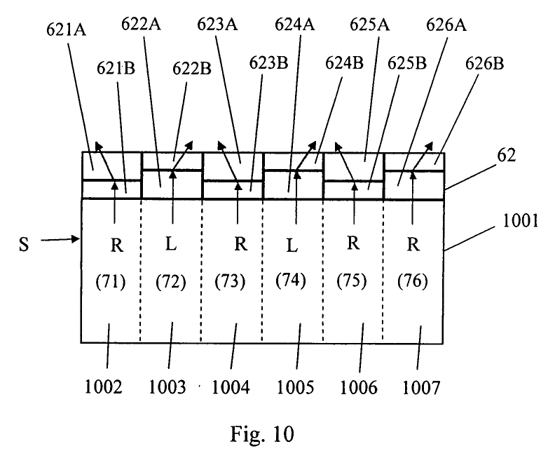

In order to observe the stereoscopic image generated from the image data deflecting toward the right side (R) and the image data deflecting toward the left side (L) having parallax obtained from FIG. 5, the specific embodiment of the method for generating a stereoscopic image as shown in FIG. 9 can be used. FIG. 10 shows a structural diagram of a specific embodiment of a stereoscopic image generating device implementing the method of FIG. 9.

As shown in step 901 of FIG. 9, a display device 1001 such as an LCD in FIG. 10 includes a plurality of pixels 1002, 1003, 1004, 1005, 1006, and 1007, and receives a signal (S) of the image data deflecting toward the right side (R) (71, 73, and 75) and the image data deflecting toward the left side (L) (72, 74, and 76) having parallax obtained from procedures in FIG. 5.

As shown in step 902 of FIG. 9, the display device 1001 alternately displays the image data deflecting toward the right side (R) and the left side (L) at adjacent pixels, respectively. For example, the image data (71, 73, and 75) deflecting toward the right side (R) are displayed at pixels 1002, 1004, and 1006, respectively, and then the image data (72, 74, and 76) deflecting toward the left side (L) are displayed at pixels 1003, 1005, and 1007, respectively.

As shown in step 903 of FIG. 9, the refraction plate 62 as in FIG. 6 is placed in front of the display device 1001 in FIG. 10. The refraction plate 62 includes a plurality of refraction regions formed by layers 621A and 621B, 622A and 622B, 623A and 623B, 624A and 624B, 625A and 625B, 626A and 626B, respectively. Two adjacent refraction regions respectively have a refraction direction opposite to each other. For example, the refraction region formed by layers 621A and 621B causes the light exiting the refraction plate 62 to deflect toward the right side (R) of a viewer, but the adjacent refraction region formed by layers 622A and 622B causes the light exiting the refraction plate 62 to deflect toward the left side (L) of a viewer.

As shown in step 904 of FIG. 9 and in FIG. 10, the refraction regions formed by layers 621A and 62 1B, 623A and 623B, and 625A and 625B in the refraction plate 62 respectively correspond to the pixels 1002, 1004, and 1006 in the display device 1001 displaying the image data deflecting toward the right side (R), and the refraction regions formed by layers 622A and 622B, 624A and 624B, and 626A and 626B in the refraction plate 62 respectively correspond to the pixels 1003, 1005, and 1007 in the display device 1001 displaying the image data deflecting toward the left side (L). As such, a viewer may observe the stereoscopic image when viewing the alternately displayed image through the refraction plate 62.

While the invention has been described in detail with reference to the above exemplary embodiments, it is not intended that such descriptions are construed in a restrictive way. With such descriptions, persons skilled in the art will comprehend various modifications and combinations of the above exemplary embodiments. Therefore, it is intended to cover any such modifications and combinations with the appended claims.

What is claimed is:

1. A method of generating image data having parallax by using a digital image-capturing device, the digital image-capturing device using a focus lens to focus a received image onto an image sensing device, so as to convert a focused image into image data of electrical form, the focus lens being movably connected to the digital image-capturing device, the method comprising:
rotating the focus lens toward a first direction by a first angle, to cause the image sensing device to obtain a first image data; and
rotating the focus lens toward a second direction opposite to the first direction by a second angle, to cause the image sensing device to obtain a second image data having parallax with respect to the first image data.

2. A method according to claim 1, wherein the first direction is clockwise, and the second direction is counterclockwise.

3. A method according to claim 1, wherein the first angle is equal or unequal to the second angle.

4. A method according to claim 1, wherein the digital image-capturing device is a digital camera or a digital camcorder.

5. A method of generating image data having parallax by using a digital image-capturing device, the digital image-capturing device using an image sensing device to convert a focused image into image data of electrical form, the image sensing device having a plurality of image sensing units, the method comprising:
providing a refraction plate having a plurality of refraction regions, two adjacent refraction regions respectively having a first refraction direction and a second refraction direction opposite to the first refraction direction; and
placing the refraction plate in contact with the image sensing device in such a way that the plurality of refraction regions respectively correspond to the plurality of image sensing units, so as to obtain, from the image sensing device, image data of the first refraction direction and image data of the second refraction direction having parallax with respect to the image data of the first refraction direction.

6. A method according to claim 5, wherein each refraction region is formed by stacking two layers of different materials, and two adjacent refraction regions respectively have a layer thickness different from each other.

7. A method according to claim 5, wherein the digital image-capturing device is a digital camera or a digital camcorder.

8. A digital image-capturing device for selectively generating image data having parallax, the digital image-capturing device comprising:
a focus lens movably connected to the digital image-capturing device for focusing a received image; and
an image sensing device for converting a focused image into image data of electrical form,
wherein the image sensing device obtains a first image data when the focus lens is rotated toward a first direction by a first angle, and the image sensing device obtains a second image data having parallax with respect to the first image data when the focus lens is rotated toward a second direction opposite to the first direction by a second angle.

9. A digital image-capturing device according to claim 8, wherein the first direction is clockwise, and the second direction is counterclockwise.

10. A digital image-capturing device according to claim 8, wherein the first angle is equal or unequal to the second angle.

11. A digital image-capturing device according to claim 8, wherein the digital image-capturing device is a digital camera or a digital camcorder.

12. A digital image-capturing device for generating image data having parallax, the digital image-capturing device comprising:
an image sensing device for converting a received image into image data of electrical form, the image sensing device having a plurality of image sensing units; and
a refraction plate contacting the image sensing device and having a plurality of refraction regions respectively corresponding to the plurality of image sensing units, two adjacent refraction regions respectively having a first refraction direction and a second refraction direction opposite to the first refraction direction, causing the image sensing device to obtain image data of the first refraction direction and image data of the second refraction direction having parallax with respect to the image data of the first refraction direction.

13. A digital image-capturing device according to claim 12, wherein each refraction region is formed by stacking two layers of different materials, and two adjacent refraction regions respectively have a layer thickness different from each other.

14. A digital image-capturing device according to claim 12, wherein the digital image-capturing device is a digital camera or a digital camcorder.

15. A stereoscopic image generating device, comprising:
a display device having a plurality of pixels and receiving image data of a first refraction direction and image data of a second refraction direction having parallax with respect to the image data of the first refraction direction, and alternately displaying image data of the first refraction direction and image data of the second refraction direction at adjacent pixels, the first refraction direction being opposite to the second refraction direction; and
a refraction plate in close proximity to the display device and having a plurality of refraction regions, two adjacent refraction regions respectively having the first refraction direction and the second refraction direction,
wherein the refraction regions having the first refraction direction and the refraction regions having the second refraction direction respectively correspond to the adjacent pixels alternately displaying image data of the first refraction direction and image data of the second refraction direction, such that a viewer can see the stereoscopic image when viewing the displayed image through the refraction plate.

16. A stereoscopic image generating device according to claim 15, wherein each refraction region is formed by stacking two layers of different materials, and two adjacent refraction regions respectively have a layer thickness different from each other.
